(19) United States
(12) Patent Application Publication
(10) Pub. No.: US 2026/0226920 A1
(43) Pub. Date: Aug. 6, 2026

(54) ELECTRIC COMPRESSOR

(71) Applicant: MITSUBISHI HEAVY INDUSTRIES ENGINE & TURBOCHARGER, LTD., Sagamihara-shi, Kanagawa (JP)

(72) Inventors: Kazuya TAKEDA, Kanagawa (JP); Makoto OGAWA, Kanagawa (JP); Takaaki YOSHIZAWA, Kanagawa (JP)

(73) Assignee: MITSUBISHI HEAVY INDUSTRIES ENGINE & TURBOCHARGER, LTD., Sagamihara-shi, Kanagawa (JP)

(21) Appl. No.: 19/156,294

(22) PCT Filed: Mar. 29, 2023
(86) PCT No.: PCT/JP2023/012923

§ 371 Date: Aug. 13, 2025

(51) Int. Cl. F04D 29/58; F04D 17/12; F04D 25/06

(52) U.S. Cl. CPC F04D 29/5806; F04D 17/122; F04D 25/0606

(57) ABSTRACT

An electric compressor comprising a housing that has a cylindrical stator in the inner peripheral part thereof, a rotating shaft that is disposed inside the housing and has a rotor facing the stator, a compressor wheel that is fixed to one axial-direction side of the rotating shaft, and a cooling water flow path that is provided in the housing on the radial-direction outside of the stator. The cooling water flow path has a plurality of first cooling water flow paths that are provided along the circumferential direction of the housing and provided at intervals in the axial direction, and a second cooling water flow path that is provided along a bending direction bent at a prescribed angle relative to the circumferential direction of the housing and that connects the ends of the plurality of first cooling water flow paths to each other.

### TECHNICAL FIELD

The present disclosure relates to an electric compressor.

### BACKGROUND ART

For example, since a fuel cell requires air having a high pressure, a two-stage compression type electric compressor is applied. The two-stage compression type electric compressor is configured such that a rotary shaft is rotatably supported by a housing, a low-pressure wheel is provided on one side of the rotary shaft in an axial direction, and a high-pressure wheel is provided on the other side in the axial direction. The electric compressor rotates a rotor by means of a suction force and a repulsive force of a magnetic force generated by causing a current to flow to a stator coil constituting a stator, and a rotary shaft integrated with the rotor rotates. Therefore, particularly, the stator (stator coil) needs to be cooled since the stator (stator coil) is at a high temperature. Generally, the electric compressor cools a stator by flowing cooling water into the housing and supplies a portion of compressed air to the stator to cool the stator. An example of such an electric compressor is described, for example, in PTL 1.

### Citation List

### Patent Literature

[PTL 1] Japanese Patent No. 5565229

### SUMMARY OF INVENTION

### Technical Problem

In the electric compressor of the related art described in PTL 1, a spiral flow path is formed in a housing, and the stator is cooled by causing cooling water to flow through the spiral flow path. In this case, since the spiral flow path has a spiral shape with respect to the center of the housing, the flow path for the cooling water cannot be provided on an inlet side and an outlet side of the cooling water. The stator includes a stator core and a stator coil, and the stator coil is wound around the stator core, and a part of the stator coil is exposed as a coil end on one side and the other side in the axial direction. Therefore, in the electric compressor of the related art, it is difficult to sufficiently cool a coil end of the stator coil with the cooling water flowing through the spiral flow path.

The present disclosure is devised to solve the above-described problems, and an object thereof is to provide an electric compressor that improves cooling performance.

### Solution to Problem

An electric compressor of the present disclosure for achieving the above object includes a housing that includes a stator having a cylindrical shape in an inner peripheral portion, a rotary shaft that is disposed inside the housing and that includes a rotor facing the stator, a compressor wheel that is fixed to one side of the rotary shaft in an axial direction, and a cooling water flow path that is provided outward of the stator in a radial direction of the housing, in which the cooling water flow path includes a plurality of first cooling water flow paths that are provided along a circumferential direction of the housing and that are provided at an interval in the axial direction, and a second cooling water flow path that is provided along a bending direction bent by a predetermined angle with respect to the circumferential direction of the housing and that connects end portions of the plurality of first cooling water flow paths to each other.

### Advantageous Effects of Invention

According to the electric compressor of the present disclosure, it is possible to improve the cooling performance.

### BRIEF DESCRIPTION OF DRAWINGS

FIG. 1 is a longitudinal cross-sectional view showing an internal configuration of an electric compressor according to a first embodiment.

FIG. 2 is a perspective view schematically showing a cooling water passage.

FIG. 3 is a perspective view showing a core for forming a cooling water passage.

FIG. 4 is a schematic view showing a shape of the cooling water passage.

FIG. 5 is a cross-sectional view showing a cooling water passage in an electric compressor of a second embodiment.

FIG. 6 is a cross-sectional view showing a cooling water passage in an electric compressor of a third embodiment.

FIG. 7 is a cross-sectional view showing a modification example of the cooling water passage in the electric compressor.

FIG. 8 is a perspective view schematically showing a cooling water passage in the electric compressor of the third embodiment.

FIG. 9 is a cross-sectional view showing the cooling water passage.

### DESCRIPTION OF EMBODIMENTS

Hereinafter, preferred embodiments of the present disclosure will be described in detail with reference to the drawings. The present disclosure is not limited by the embodiments, and when a plurality of the embodiments are provided, the present disclosure also includes a configuration in which the respective embodiments are combined with each other. In addition, configuration elements in the embodiments include those which can be easily assumed by those skilled in the art, those which are substantially the same, and those which have a so-called equivalent scope.

### First Embodiment

### Configuration of Electric Compressor

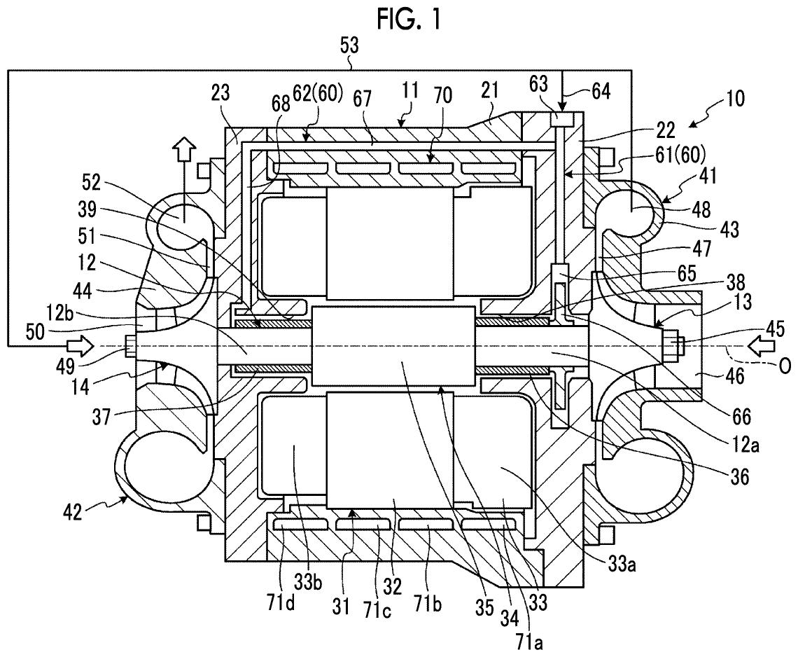

FIG. 1 is a longitudinal cross-sectional view showing an internal configuration of an electric compressor according to a first embodiment.

As shown in FIG. 1, an electric compressor 10 is a two-stage compression type electric compressor. The electric compressor 10 includes a housing 11, a rotary shaft 12, a low-pressure wheel 13, and a high-pressure wheel 14.

The housing 11 includes a motor housing 21, a low-pressure side bearing housing 22, and a high-pressure side bearing housing 23. The motor housing 21 has a cylindrical shape. The low-pressure side bearing housing 22 has a disk shape and is disposed on one side (right side in FIG. 1) in an axial direction in the motor housing 21. The low-pressure side bearing housing 22 is detachably fastened to an end portion on one side of the motor housing 21 in the axial direction by a plurality of bolts (not shown). The high-pressure side bearing housing 23 has a disk shape and is disposed on the other side (left side in FIG. 1) of the motor housing 21 in the axial direction. The high-pressure side bearing housing 23 is detachably fastened to an end portion on the other side of the motor housing 21 in the axial direction by a plurality of bolts (not shown).

One opening of the motor housing 21 in the axial direction is closed by the low-pressure side bearing housing 22, and the other opening of the motor housing 21 in the axial direction is closed by the high-pressure side bearing housing 23. Therefore, the housing 11 has a hollow shape by fastening the low-pressure side bearing housing 22 and the high-pressure side bearing housing 23 to the motor housing 21.

A stator 31 is fixed to an inner peripheral portion of the motor housing 21. The stator 31 has a cylindrical shape. The stator 31 includes a stator core 32 and a stator coil 33. The stator core 32 has a cylindrical shape and is fixed such that an outer peripheral surface thereof is in close contact with an inner peripheral surface of the motor housing 21. The stator coil 33 is wound around the stator core 32, a part of the stator coil 33 is stored inside the stator core 32, a low-pressure side coil end 33a is exposed to one side of the stator core 32 in the axial direction, and a high-pressure side coil end 33b is exposed to the other side of the stator core 32 in the axial direction.

The rotary shaft 12 is disposed inside the housing 11. The rotary shaft 12 is disposed along an axial center O concentric with the housing 11, and is rotatably supported by the housing 11 around the axial center O. A rotor 34 is fixed to an outer peripheral portion of the rotary shaft 12 at an intermediate position in the axial direction. The rotor 34 has a rotor iron core (permanent magnet) 35. The rotor iron core 35 has a cylindrical shape and is fixed to an outer peripheral surface of the rotary shaft 12.

In the stator 31 and the rotor 34, an inner peripheral surface and an outer peripheral surface face each other in a radial direction. A gap is provided between the inner peripheral surface and the outer peripheral surface of the stator 31 and the rotor 34. Therefore, when a current flows through the stator coil 33 of the stator 31, the rotor 34 rotates due to a suction force and a repulsive force of a magnetic force generated, and the rotary shaft 12 outputs a rotational force.

The rotary shaft 12 is rotatably supported by the housing 11 by a low-pressure side air bearing 38 and a high-pressure side air bearing 39. The rotary shaft 12 is provided with a low-pressure side shaft portion 12a on one side in the axial direction with respect to the rotor 34, and is provided with a high-pressure side shaft portion 12b on the other side in the axial direction with respect to the rotor 34. In the rotary shaft 12, the low-pressure side shaft portion 12a is integrally rotatably mounted with a low-pressure side bearing sleeve 36, and the high-pressure side shaft portion 12b is integrally rotatably mounted with a high-pressure side bearing sleeve 37. The low-pressure side bearing sleeve 36 functions as a low-pressure side shaft portion, and the high-pressure side bearing sleeve 37 functions as a high-pressure side shaft portion. It is to be noted that the low-pressure side bearing sleeve 36 and the high-pressure side bearing sleeve 37 may not be provided, and the rotary shaft 12 may be directly supported by the low-pressure side air bearing 38 and the high-pressure side air bearing 39.

The low-pressure side air bearing 38 is integrally provided in the low-pressure side bearing housing 22. The low-pressure side air bearing 38 has a cylindrical shape and is formed to extend from an inner surface of the low-pressure side bearing housing 22 to the rotor 34 side. The low-pressure side air bearing 38 is disposed on an outer side of the low-pressure side bearing sleeve 36 mounted on the rotary shaft 12. In addition, when the rotary shaft 12 is directly supported by the low-pressure side air bearing 38, the low-pressure side air bearing 38 is disposed on an outer side of the rotary shaft 12. A low-pressure side gap is secured between an inner peripheral surface of the low-pressure side air bearing 38 and an outer peripheral surface of the low-pressure side bearing sleeve 36.

The high-pressure side air bearing 39 is integrally provided in the high-pressure side bearing housing 23. The high-pressure side air bearing 39 has a cylindrical shape and is formed to extend from an inner surface of the high-pressure side bearing housing 23 to the rotor 34 side. The high-pressure side air bearing 39 is disposed on an outer side of the high-pressure side bearing sleeve 37 mounted on the rotary shaft 12. In addition, when the rotary shaft 12 is directly supported by the high-pressure side air bearing 39, the high-pressure side air bearing 39 is disposed on the outer side of the rotary shaft 12. A high-pressure side gap is secured between an inner peripheral surface of the high-pressure side air bearing 39 and an outer peripheral surface of the high-pressure side bearing sleeve 37.

In the housing 11, a low-pressure compressor 41 is disposed on the low-pressure side bearing housing 22 side, and a high-pressure compressor 42 is disposed on the high-pressure side bearing housing 23 side. The low-pressure compressor 41 includes a low-pressure side housing 43 and the low-pressure wheel 13. The high-pressure compressor 42 includes a high-pressure side housing 44 and the high-pressure wheel 14.

The low-pressure side housing 43 is fastened to an outer surface of the low-pressure side bearing housing 22 by a plurality of bolts. The low-pressure wheel 13 is disposed inside the low-pressure side housing 43. The low-pressure wheel 13 is integrally rotatable and fixed to one end portion of the rotary shaft 12 in the axial direction by a bolt 45. The low-pressure compressor 41 is provided with an intake port 46, a diffuser part 47, a scroll part 48 having a spiral shape, and a discharge port (not shown) by means of the low-pressure side housing 43 and the low-pressure wheel 13.

The high-pressure side housing 44 is fastened to an outer surface of the high-pressure side bearing housing 23 by a plurality of bolts. The high-pressure wheel 14 is disposed inside the high-pressure side housing 44. The high-pressure wheel 14 is integrally rotatable and fixed to the other end portion of the rotary shaft 12 in the axial direction by a bolt 49. The high-pressure compressor 42 is provided with an intake port 50, a diffuser part 51, a scroll part 52 having a spiral shape, and a discharge port (not shown) by the high-pressure side housing 44 and the high-pressure wheel 14.

In addition, the discharge port (not shown) and the intake port 50 of the low-pressure compressor 41 and of the high-pressure compressor 42 are connected to each other by a connection flow path 53.

In the low-pressure compressor 41, when the low-pressure wheel 13 rotates, external air is suctioned from the intake port 46 and is accelerated and compressed by a centrifugal force of the low-pressure wheel 13, and the accelerated and compressed air is decelerated by the diffuser part 47, and then flows through the scroll part 48 and is discharged from the discharge port. The low-pressure air compressed by the low-pressure compressor 41 is fed to the high-pressure compressor 42 by the connection flow path 53. In the high-pressure compressor 42, when the high-pressure wheel 14 rotates, the external air is suctioned from the intake port 50 and is accelerated and compressed by a centrifugal force of the high-pressure wheel 14, and the accelerated and compressed air is decelerated by the diffuser part 51, and then flows through the scroll part 52 and is discharged from the discharge port.

### Air Flow Path

As shown in FIG. 1, the electric compressor 10 includes an air flow path 60. The air flow path 60 includes a first air flow path 61 and a second air flow path 62. The first air flow path 61 supplies the compressed air from the housing 11 to the low-pressure side air bearing 38. The first air flow path 61 is provided in the low-pressure side bearing housing 22 along the radial direction. The first air flow path 61 is provided with an air intake port 63 at one end on an outer side in the radial direction. The air intake port 63 is connected to an air bleeding flow path 64 branched from the connection flow path 53. In the first air flow path 61, a portion of the low-pressure air (compressed air) discharged from the low-pressure compressor 41 is bled by the air bleeding flow path 64 and supplied to the air intake port 63. In addition, the air intake port 63 may be connected to an air bleeding flow path that bleeds the high-pressure air (compressed air) discharged from the high-pressure compressor 42. The low-pressure side bearing housing 22 is provided with a low-pressure side space portion 65 on an outer peripheral edge of the axial center O. The other end on an inner side in the radial direction of the first air flow path 61 communicates with the low-pressure side space portion 65.

A thrust disk 66 that constitutes a thrust bearing is fixed to the rotary shaft 12. The thrust disk 66 is fixed between the low-pressure side bearing sleeve 36 and the low-pressure wheel 13 in the rotary shaft 12. The thrust disk 66 rotates integrally with the rotary shaft 12. The thrust disk 66 is disposed in the low-pressure side space portion 65. The low-pressure side space portion 65 communicates with a low-pressure side gap between the inner peripheral surface of the low-pressure side air bearing 38 and the outer peripheral surface of the low-pressure side bearing sleeve 36.

The compressed air flowing through the first air flow path 61 is supplied to the low-pressure side space portion 65 to cool a support surface (one surface and the other surface in the axial direction in the low-pressure side space portion 65) that supports the thrust disk 66. Then, the compressed air in the low-pressure side space portion 65 is supplied to the low-pressure side air bearing 38. That is, the compressed air is supplied to the low-pressure side gap between the inner peripheral surface of the low-pressure side air bearing 38 and the outer peripheral surface of the low-pressure side bearing sleeve 36, so that the rotary shaft 12 is lifted and supported at a predetermined position in the radial direction. Thereafter, the compressed air supplied to the low-pressure side air bearing 38 is discharged to the outside from a discharge port (not shown) provided in the housing 11.

The second air flow path 62 is provided to be branched from the first air flow path 61, and supplies the compressed air to the high-pressure side air bearing 39. The second air flow path 62 includes an axial direction air flow path 67 and a radial direction air flow path 68. The axial direction air flow path 67 is branched from the first air flow path 61 and is provided along the axial direction of the rotary shaft 12 in the motor housing 21. The radial direction air flow path 68 communicates with the axial direction air flow path 67, and is provided along the radial direction of the rotary shaft 12 in the high-pressure side bearing housing 23. The radial direction air flow path 68 communicates with a high-pressure side gap between the inner peripheral surface of the high-pressure side air bearing 39 and the outer peripheral surface of the high-pressure side bearing sleeve 37.

The compressed air branched from the first air flow path 61 flows in the axial direction through the axial direction air flow path 67 of the second air flow path 62, then flows inward in the radial direction through the radial direction air flow path 68 and is supplied to the high-pressure side air bearing 39. That is, the compressed air is supplied to the high-pressure side gap between the inner peripheral surface of the high-pressure side air bearing 39 and the outer peripheral surface of the high-pressure side bearing sleeve 37, so that the rotary shaft 12 is lifted and supported at a predetermined position in the radial direction. Thereafter, the compressed air supplied to the high-pressure side air bearing 39 flows into a gap between the stator 31 and the rotor 34 to cool the stator core 32 and the stator coil 33 of the stator 31. The compressed air for cooling the stator 31 is discharged to the outside from a discharge port (not shown) provided in the housing 11.

### Cooling Water Flow Path

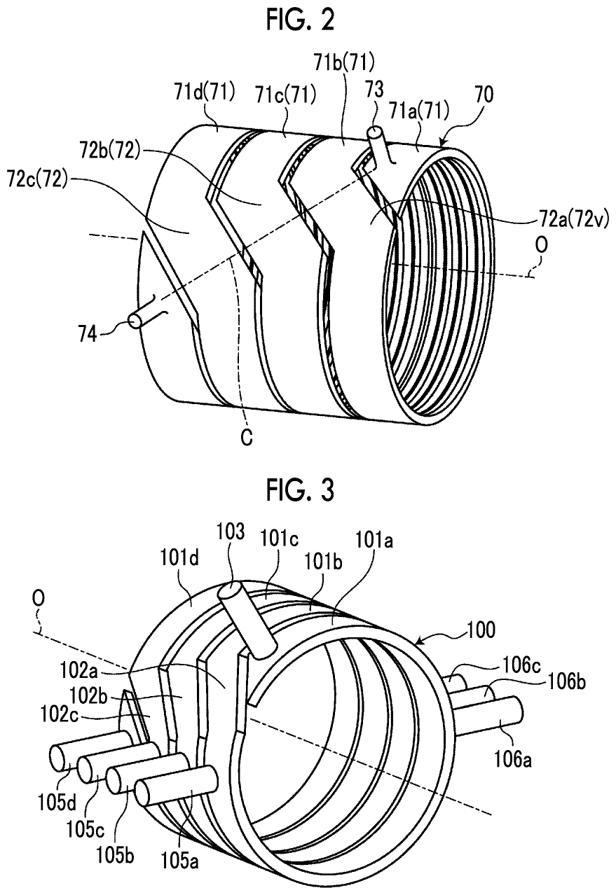

FIG. 2 is a perspective view schematically showing the cooling water passage.

As shown in FIG. 1, the electric compressor 10 includes a cooling water flow path 70. The cooling water flow path 70 is provided outward in the radial direction of the stator 31 in the housing 11 and inward in the radial direction of the axial direction air flow path 67 constituting the second air flow path 62 in the air flow path 60. In the present embodiment, the cooling water flow path 70 is disposed on the inner side in the radial direction of the axial direction air flow path 67 constituting the second air flow path 62 in the air flow path 60. However, the present disclosure is not limited thereto. The cooling water flow path 70 may be disposed outward in the radial direction of the axial direction air flow path 67 constituting the second air flow path 62 in the air flow path 60.

As shown in FIGS. 1 and 2, the cooling water flow path 70 includes a plurality of first cooling water flow paths 71 and a plurality of second cooling water flow paths 72.

The first cooling water flow paths 71 include a plurality of (four in the present embodiment) flow paths 71a, 71b, 71c, and 71d. The plurality of flow paths 71a, 71b, 71c, and 71d are provided along the circumferential direction of the motor housing 21. The plurality of flow paths 71a, 71b, 71c, and 71d are disposed at an interval in the axial direction of the motor housing 21. The plurality of flow paths 71a, 71b, 71c, and 71 d are disposed in a range of a predetermined angle (for example, 270 degrees to 300 degrees) in the circumferential direction of the motor housing 21. At this time, the plurality of flow paths 71a, 71b, 71c, and 71d are disposed to be shifted by a predetermined angle in the circumferential direction of the motor housing 21.

The second cooling water flow paths 72 include a plurality of (three in the present embodiment) flow paths 72a, 72b, and 72c. The second cooling water flow paths 72 connect end portions of the plurality of first cooling water flow paths 71 to each other. That is, the plurality of flow paths 72a, 72b, and 72c connect the end portions of the plurality of flow paths 71a, 71b, 71c, and 71d to each other. The plurality of flow paths 72a, 72b, and 72c are provided along a bending direction in which the flow paths are bent by a predetermined angle with respect to the circumferential direction of the motor housing 21. The plurality of flow paths 72a, 72b, and 72c are disposed at an interval in the axial direction of the motor housing 21. The plurality of flow paths 72a, 72b, and 72c are disposed in a range of a predetermined angle (for example, 60 degrees to 90 degrees) in the circumferential direction of the motor housing 21. At this time, the plurality of flow paths 72a, 72b, and 72c are disposed to be shifted by a predetermined angle in the circumferential direction of the motor housing 21. The flow path 72a connects the end portion of the flow path 71a and the end portion of the flow path 71b, the flow path 72b connects the end portion of the flow path 71b and the end portion of the flow path 71c, and the flow path 72c connects the end portion of the flow path 71c and the end portion of the flow path 71d.

In the first cooling water flow paths 71, the flow path 71a disposed on one side of the motor housing 21 in the axial direction is disposed over substantially the entire region of the motor housing in the circumferential direction, and an outlet portion 73 of cooling water is provided at an end portion thereof. In addition, in the first cooling water flow paths 71, the flow path 71d disposed on the other side of the motor housing 21 in the axial direction is disposed over substantially the entire region of the motor housing 21 in the circumferential direction, and an inlet portion 74 of cooling water is provided at an end portion thereof.

The first cooling water flow paths 71 are disposed such that the flow path 71a provided with the outlet portion 73 faces the coil end 33a of the stator coil 33 constituting the stator 31. In addition, the first cooling water flow paths 71 are disposed such that the flow path 71d provided with the inlet portion 74 faces the coil end 33b of the stator coil 33 constituting the stator 31.

In the first cooling water flow paths 71, the plurality of flow paths 71a, 71b, 71c, and 71d are disposed to be shifted by a predetermined angle in the circumferential direction of the motor housing 21. Similarly, in the second cooling water flow paths 72, the plurality of flow paths 72a, 72b, and 72c are disposed to be shifted by a predetermined angle in the circumferential direction of the motor housing 21. The flow paths 72a, 72b, and 72c connect the end portions of the flow paths 71a, 71b, 71c, and 71d adjacent to each other. Therefore, the plurality of flow paths 72a, 72b, and 72c constituting the second cooling water flow paths 72 are inclined by a predetermined angle with respect to the axial center O, and are disposed at an interval along a connection line C passing through the outlet portion 73 and the inlet portion 74.

The cooling water is supplied to the inlet portion 74 provided in the motor housing 21, flows through the plurality of first cooling water flow paths 71 and the plurality of second cooling water flow paths 72, and is discharged to the outside from the outlet portion 73. That is, the cooling water flows from the inlet portion 74 to the outlet portion 73 through the flow path 71a, the flow path 72a, the flow path 71b, the flow path 72b, the flow path 71c, the flow path 72ca, and the flow path 71d. At this time, the stator core 32 and the stator coil 33 in the stator 31 are cooled by the cooling water flowing inside the motor housing 21.

### Configuration of Core

FIG. 3 is a perspective view showing a core for forming a cooling water passage.

The motor housing 21 is manufactured by casting. As shown in FIG. 3, a core 100 for manufacturing the motor housing 21 includes ring portions 101a, 101b, 101c, and 101d corresponding to the flow paths 71a, 71b, 71c, and 71d of the first cooling water flow paths 71, and bent portions 102a, 102b, and 102c corresponding to the flow paths 72a, 72b, and 72c of the second cooling water flow paths 72. A circular columnar portion 103 corresponding to the outlet portion 73 is provided in the ring portion 101a, and a circular columnar portion (not shown) corresponding to the inlet portion 74 is provided in the ring portion 101d.

A plurality of core prints 105a, 105b, 105c, 105d, 106a, 106b, and 106c are connected to the ring portions 101a, 101b, 101c, and 101d and the bent portions 102a, 102b, and 102c of the core 100. Meanwhile, although not illustrated, an outer mold is divided into three parts which are an upper mold and a lower mold corresponding to the ring portions 101a, 101b, 101c, and 101d, and a side mold corresponding to the bent portions 102a, 102b, and 102c. The plurality of core prints 105a, 105b, 105c, 105d, 106a, 106b, and 106c are provided with respect to the ring portions 101a, 101b, 101c, and 101d and the bent portions 102a, 102b, and 102c, so that the castability of the core 100 can be improved and the core 100 can be prevented from being deviated from a mold at the time of casting.

### Second Cooling Water Flow Path

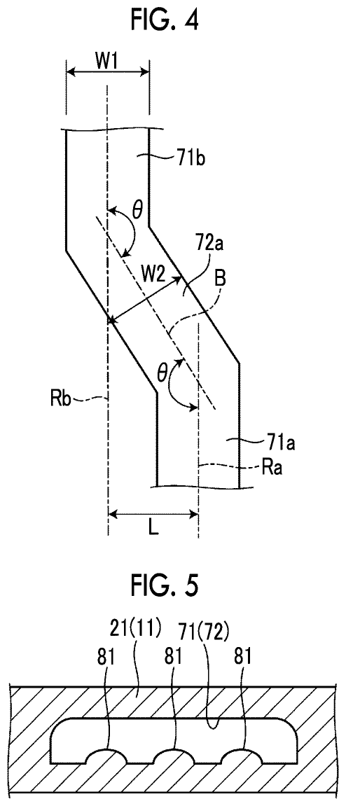

FIG. 4 is a schematic view showing a shape of a cooling water passage.

As shown in FIG. 4, in the first cooling water flow paths 71, the flow path 71a and the flow path 71b are connected to each other by the flow path 72a of the second cooling water flow paths 72. The flow paths 71a and 71b are disposed along circumferential direction lines Ra and Rb along the circumferential direction of the motor housing 21, and are disposed to be separated from each other by a distance L in the axial direction of the motor housing 21. The flow path 72a is disposed along a curved line B bent by a predetermined angle θ with respect to the circumferential direction lines Ra and Rb, and each end portion is connected to the flow path 71a and the flow path 71 b. The predetermined angle θ is preferably set in a range of, for example, 10 degrees to 40 degrees in consideration of a pressure loss of the cooling water flowing through the first cooling water flow paths 71 and the second cooling water flow paths 72. In this case, it is preferable that the connecting portion between the flow path 71a and the flow path 72a and the connecting portion between the flow path 71b and the flow path 72a are connected at the curved portion.

A passage cross-sectional area of the flow paths 71a and 71b (71c and 71d) constituting the first cooling water flow paths 71 and a passage cross-sectional area of the flow paths 72a (72b and 72c) constituting the second cooling water flow paths 72 are the same. That is, a width W1 of the flow paths 71a and 71b (71c and 71d) and a width W2 of the flow paths 72a (72b and 72c) are the same. In addition, a height of the flow paths 71a and 71b (71c and 71d) and a height of the flow path 72a (72b and 72c) are the same.

Here, the passage cross-sectional area is a passage area when the flow paths 71a and 71b (71c and 71d) and the flow path 72a (72b and 72c) are cross-sectioned in a direction orthogonal to a longitudinal direction (a direction in which the cooling water flows). However, in the vicinity of a connecting portion between the flow paths 71a and 71b (71c and 71d) and the flow path 72a (72b and 72c), the passage cross-sectional area of the flow paths 71a and 71b (71c and 71d) and the passage cross-sectional area of the flow path 72a (72b and 72c) may be different from each other.

### Operation of Electric Compressor

As shown in FIGS. 1 and 2, the electric compressor 10 causes the rotor 34 to rotate by flowing a current to the stator coil 33 constituting the stator 31, and the rotary shaft 12 integrated with the rotor 34 rotates. The rotary shaft 12 includes the low-pressure wheel 13 and the high-pressure wheel 14 connected to each end portion. Therefore, in particular, the stator 31 becomes high in temperature. The electric compressor 10 is an air-cooled type and a water-cooled type. That is, the electric compressor 10 bleeds a portion of the compressed air compressed by the low-pressure wheel 13, supplies the portion of the compressed air to the air flow path 60, supplies the portion of the compressed air to the low-pressure side air bearing 38 and the high-pressure side air bearing 39, and then supplies the portion of the compressed air to the stator 31 to cool the stator 31.

In addition, the electric compressor 10 supplies cooling water from the outside to the cooling water flow path 70 to cool the stator core 32 and the stator coil 33 of the stator 31. At this time, since the flow paths 71a, 71b, 71c, and 71d are disposed to reach each end portion of the motor housing 21 in the axial direction, the first cooling water flow path 71 constituting the cooling water flow path 70 can cool each of the coil ends 33a and 33b of the stator coil 33. That is, in the stator 31, since the stator core 32 and the stator coil 33 are sufficiently cooled by the cooling water, a flow rate of the compressed air as the cooling air can be reduced. Therefore, by using the compressed air mainly for the stator 31 and the rotor 34, air shortage in the stator 31 and the rotor 34 can be suppressed, and the stator 31 and the rotor 34 can be sufficiently cooled.

### Second Embodiment

FIG. 5 is a cross-sectional view showing a cooling water passage in an electric compressor of a second embodiment. It is noted that a basic configuration of the second embodiment is the same as that of the above-described first embodiment, and description will be made with reference to FIGS. 1 and 2. A member having the same function as in the above-described first embodiment will be denoted by the same reference numeral, and detailed description thereof will be omitted.

As shown in FIGS. 1 and 2, the cooling water flow path 70 includes a plurality of first cooling water flow paths 71 and a plurality of second cooling water flow paths 72.

As shown in FIG. 5, the first cooling water flow paths 71 and the second cooling water flow paths 72 are provided with a plurality of convex portions 81 on an inner surface. The convex portions 81 have a shape along the circumferential direction of the motor housing 21, and are disposed at an interval in the axial direction of the motor housing 21. In addition, the convex portions 81 have a semicircular cross-sectional shape, but may have a rectangular cross-sectional shape, a trapezoidal cross-sectional shape, or the like. In addition, the convex portions 81 are provided on one inner surface of four inner surfaces that define the first cooling water flow paths 71 and the second cooling water flow paths 72, but may be provided on a plurality of inner surfaces. Further, the convex portions 81 have a shape along the circumferential direction of the motor housing 21. However, the convex portions 81 may be simple protrusions, and the plurality of convex portions 81 may be provided at an interval in the circumferential direction of the motor housing 21.

The first cooling water flow paths 71 and the second cooling water flow paths 72 can change a flow path area by adjusting the number of the convex portions 81 provided on the inner surface. Therefore, a flow rate or a flow speed of the cooling water flowing through the first cooling water flow paths 71 and the second cooling water flow paths 72 can be adjusted, and cooling efficiency can be improved.

### Third Embodiment

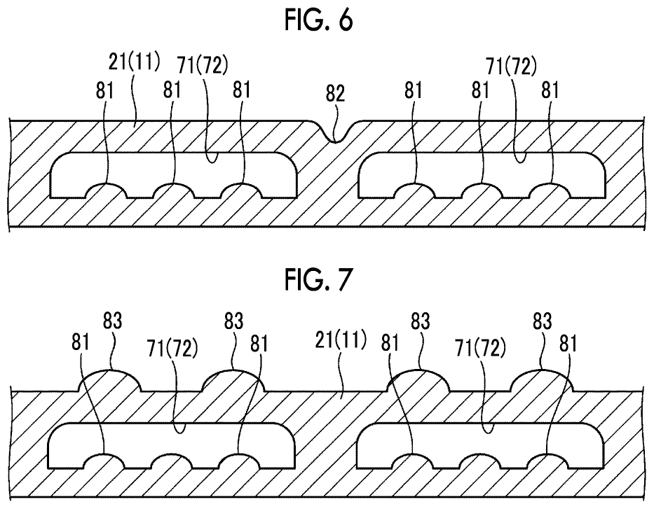

FIG. 6 is a cross-sectional view showing a cooling water passage in an electric compressor of a third embodiment. A basic configuration of the third embodiment is the same as that of the first embodiment and the second embodiment described above, and description will be made with reference to FIGS. 1 and 2. A member having the same function as in the first embodiment and the second embodiment described above will be denoted by the same reference numeral, and detailed description thereof will be omitted.

As shown in FIG. 6, the motor housing 21 is provided with a concave portion 82 on an outer surface of the plurality of first cooling water flow paths 71 and the plurality of second cooling water flow paths 72 on an outer side in the radial direction. The concave portion 82 has a shape along the circumferential direction of the motor housing 21, and is disposed at an interval in the axial direction of the motor housing 21. The concave portion 82 is disposed between the first cooling water flow paths 71 and the second cooling water flow paths 72 on an outer surface of the motor housing 21. In addition, the concave portion 82 has a semicircular shape, but may have a quadrangular shape, a trapezoidal shape, or the like. In addition, the concave portion 82 has a shape along the circumferential direction of the motor housing 21. However, the concave portion 82 may be a simple protrusion, and a plurality of the concave portions 82 may be provided at an interval in the circumferential direction of the motor housing 21.

The motor housing 21 can increase the surface area by providing the concave portion 82 on the outer surface of the first cooling water flow paths 71 and the second cooling water flow paths 72. Therefore, the cooling efficiency of the cooling water flowing through the motor housing 21 and the first cooling water flow paths 71 and the second cooling water flow paths 72 can be improved.

### Modification Example

FIG. 7 is a cross-sectional view showing a modification example of the cooling water passage in the electric compressor.

As shown in FIG. 7, the motor housing 21 is provided with a convex portion 83 on outer surfaces of the plurality of first cooling water flow paths 71 and the second cooling water flow paths 72 in the radial direction. The convex portion 83 has a shape along the circumferential direction of the motor housing 21, and is disposed at an interval in the axial direction of the motor housing 21. In addition, the convex portion 83 has a semicircular shape, but may have a quadrangular shape, a trapezoidal shape, or the like. In addition, the convex portion 83 has a shape along the circumferential direction of the motor housing 21. However, the convex portion 83 may be a simple protrusion, and a plurality of the convex portions 83 may be provided at an interval in the circumferential direction of the motor housing 21.

In the motor housing 21, the convex portion 83 is provided on the outer surface of the first cooling water flow paths 71 and the second cooling water flow paths 72, so that the surface area can be increased. Therefore, the cooling efficiency of the cooling water flowing through the motor housing 21 and the first cooling water flow paths 71 and the second cooling water flow paths 72 can be improved.

### Fourth Embodiment

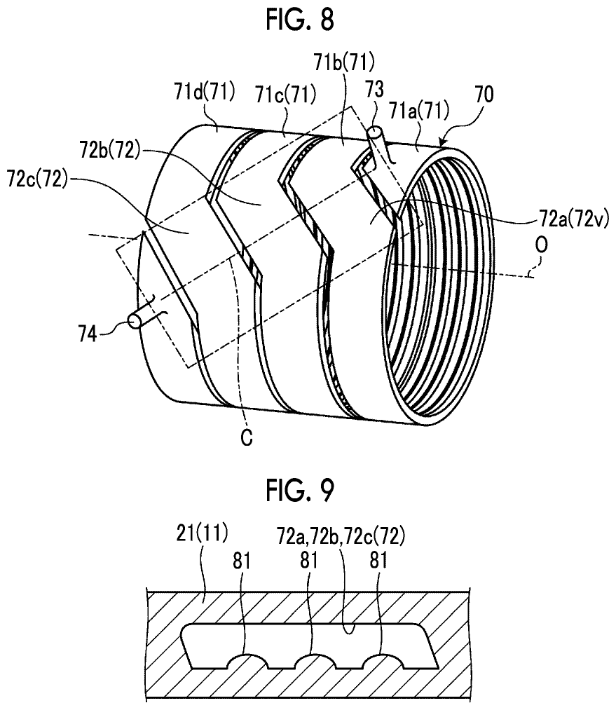

FIG. 8 is a perspective view schematically showing a cooling water passage in an electric compressor of a fourth embodiment, and FIG. 9 is a cross-sectional view showing the cooling water passage. It is noted that a basic configuration of the fourth embodiment is the same as that of the above-described first embodiment, and description will be made with reference to FIG. 2. A member having the same function as in the above-described first embodiment will be denoted by the same reference numeral, and detailed description thereof will be omitted.

As shown in FIGS. 8 and 9, the second cooling water flow paths 72 include a plurality of flow paths 72a, 72b, and 72c disposed at an interval in the axial direction of the motor housing 21. In this case, the plurality of flow paths 72a, 72b, and 72c are disposed at an interval along the connection line C inclined by a predetermined angle with respect to the axial center O. The flow paths 72a, 72b, and 72c have a quadrilateral shape with unequal sides as a passage cross-sectional shape. That is, a gap shape between the flow paths 72a, 72b, and 72c has a rectangular shape with unequal sides, and faces one direction. FIG. 9 is a passage cross-sectional shape of an end portion of the flow path 72a connected to an end portion of the flow path 71b. As shown in FIG. 9, the flow path 72a has a parallelogram shape.

As described above, the core 100 (refer to FIG. 3) is used to manufacture the cooling water flow path 70, and an outer mold is divided into three parts: an upper mold and a lower mold corresponding to the first cooling water flow paths 71, and a side mold corresponding to the second cooling water flow paths 72. The upper mold, the lower mold, and the side mold are extracted outward in the radial direction with respect to the core 100. Therefore, the passage cross-sectional shape of the flow paths 72a, 72b, and 72c is set to a quadrilateral shape with unequal sides, so that the side mold can be easily extracted from the core 100.

### Operational Effects of Present Embodiment

According to a first aspect, there is provided an electric compressor including: a housing 11 that includes a stator 31 having a cylindrical shape in an inner peripheral portion; a rotary shaft 12 that is disposed inside the housing 11 and that includes a rotor 34 facing the stator 31; a low-pressure wheel 13 (compressor wheel) that is fixed to one side of the rotary shaft 12 in an axial direction; and a cooling water flow path 70 that is provided outward of the stator 31 in a radial direction of the housing 11, in which the cooling water flow path 70 includes a plurality of first cooling water flow paths 71 that are provided along a circumferential direction of the housing 11 and that are provided at an interval in the axial direction, and a second cooling water flow path 72 that is provided along a bending direction bent by a predetermined angle with respect to the circumferential direction of the housing 11 and that connects end portions of the plurality of first cooling water flow paths 71 to each other.

According to the electric compressor according to the first aspect, the first cooling water flow paths 71 can be disposed at each end portion of the housing 11 in the axial direction, and cooling water can be caused to flow to each end portion of the housing 11 in the axial direction to perform cooling. Therefore, not only the stator core 32 in the stator 31 but also the coil ends 33a and 33b of the stator coil 33 can be cooled, and thus the cooling performance can be improved.

According to second aspect, in the electric compressor according to the first aspect, among the plurality of first cooling water flow paths 71, the first cooling water flow path 71 (flow path 71d) disposed on one side of the housing 11 in the axial direction is disposed over an entire region of the housing 11 in the circumferential direction and is provided with an inlet portion 74 of cooling water at an end portion, and among the plurality of first cooling water flow paths 71, the first cooling water flow path 71 (flow path 71a) disposed on the other side of the housing 11 in the axial direction is disposed over the entire region of the housing 11 in the circumferential direction and is provided with an outlet portion 73 of cooling water at an end portion. In this manner, the coil ends 33a and 33b of the stator coil 33 can be sufficiently cooled by the cooling water.

According to a third aspect, in the electric compressor according to the second aspect, the first cooling water flow path 71 (flow path 71d) provided with the inlet portion 74 and the first cooling water flow path 71 (flow path 71a) provided with the outlet portion 73 are disposed to face the coil ends 33a and 33b of the stator coil 33 constituting the stator 31. In this manner, the coil ends 33a and 33b of the stator coil 33 can be sufficiently cooled by the cooling water.

According to a fourth aspect, in the electric compressor according to the second aspect, a passage cross-sectional area in the first cooling water flow paths 71 and a passage cross-sectional area in the second cooling water flow path 72 are the same as each other. In this manner, a flow speed of the cooling water flowing through the first cooling water flow paths 71 and the second cooling water flow path 72 is not changed, and thus a pressure loss can be reduced to improve the cooling performance.

According to a fifth aspect, in the electric compressor according to any one of the first to fourth aspects, a plurality of the second cooling water flow paths 72 are provided and are disposed at an interval in a direction inclined by a predetermined angle with respect to the axial direction of the housing 11. In this manner, a gap between the plurality of first cooling water flow paths 71 can be narrowed, and thus the cooling performance can be improved.

According to a sixth aspect, in the electric compressor according to any one of the first to fifth aspects, the first cooling water flow paths 71 and the second cooling water flow path 72 are provided with a convex portion 81 on an inner surface. In this manner, the cooling performance can be improved by increasing an area of the inner surface.

According to a seventh aspect, in the electric compressor according to any one of the first to sixth aspects, the housing 11 is provided with a convex portion 83 or a concave portion 82 on an outer surface of the plurality of first cooling water flow paths 71 and the second cooling water flow path 72 in the radial direction. In this manner, the cooling performance can be improved by increasing a surface area.

According to an eighth aspect, in the electric compressor according to any one of the first to seventh aspects, a plurality of the second cooling water flow paths 72 are disposed at an interval in the axial direction of the housing 11, and the passage cross-sectional shape of the second cooling water flow path 72 is a quadrilateral shape with unequal sides. Accordingly, when the housing 11 is manufactured by casting, extractability of a mold can be improved.

In the above-described embodiment, the electric compressor 10 has been described as a two-stage compression type electric compressor. However, the electric compressor may be a single-stage compression type electric compressor. In addition, the bearing is an air bearing, but may be another bearing.

### Reference Signs List

10 Electric compressor
11 Housing
12 Rotary shaft
12a Low-pressure side shaft portion
12b High-pressure side shaft portion
13 Low-pressure wheel
14 High-pressure wheel
21 Motor housing
22 Low-pressure side bearing housing
23 High-pressure side bearing housing
31 Stator
32 Stator core
33 Stator coil
33a Low-pressure side coil end
33b High-pressure side coil end
34 Rotor
35 Rotor iron core
36 Low-pressure side bearing sleeve
37 High-pressure side bearing sleeve
38 Low-pressure side air bearing
39 High-pressure side air bearing
41 Low-pressure compressor
42 High-pressure compressor
43 Low-pressure side housing
44 High-pressure side housing
45, 49 Bolt
46, 50 Intake port
47, 51 Diffuser part
48, 52 Scroll part
53 Connection flow path
60 Air flow path
61 First air flow path
62 Second air flow path
63 Air intake port
64 Air bleeding flow path
65 Low-pressure side space portion
66 Thrust disk
67 Axial direction air flow path
68 Radial direction air flow path
70 Cooling water flow path
71 First cooling water flow path
71a, 71b, 71c, 71d Flow path
72 Second cooling water flow path
72a, 72b, 72c Flow path
73 Outlet portion
74 Inlet portion
81 Convex portion
82 Concave portion
83 Convex portion

1. An electric compressor, comprising:
a housing that includes a stator having a cylindrical shape in an inner peripheral portion;
a rotary shaft that is disposed inside the housing and that includes a rotor facing the stator;
a compressor wheel that is fixed to one side of the rotary shaft in an axial direction; and
a cooling water flow path that is provided outward of the stator in a radial direction of the housing,
wherein the cooling water flow path includes
a plurality of first cooling water flow paths that are provided along a circumferential direction of the housing and that are provided at an interval in the axial direction, and
a second cooling water flow path that is provided along a bending direction bent by a predetermined angle with respect to the circumferential direction of the housing and that connects end portions of the plurality of first cooling water flow paths to each other.

2. The electric compressor according to claim 1,
wherein among the plurality of first cooling water flow paths, the first cooling water flow paths disposed on one side of the housing in the axial direction are disposed over an entire region of the housing in the circumferential direction and are provided with an inlet portion of cooling water at an end portion, and among the plurality of first cooling water flow paths, the first cooling water flow paths disposed on the other side of the housing in the axial direction are disposed over the entire region of the housing in the circumferential direction and are provided with an outlet portion of cooling water at an end portion.

3. The electric compressor according to claim 2,
wherein the first cooling water flow paths provided with the inlet portion and the first cooling water flow paths provided with the outlet portion are disposed to face a coil end of a stator coil constituting the stator.

4. The electric compressor according to claim 1,
wherein a passage cross-sectional area in the first cooling water flow paths and a passage cross-sectional area in the second cooling water flow path are the same as each other.

5. The electric compressor according to claim 1,
wherein a plurality of the second cooling water flow paths are provided and are disposed at an interval in a direction inclined by a predetermined angle with respect to the axial direction of the housing.

6. The electric compressor according to claim 1,
wherein the first cooling water flow paths and the second cooling water flow path are provided with convex portions on inner surfaces.

7. The electric compressor according to claim 1,
wherein the housing is provided with a convex portion or a concave portion on an outer surface of the plurality of first cooling water flow paths and the second cooling water flow path on an outer side in the radial direction.

8. The electric compressor according to claim 1,
wherein a plurality of the second cooling water flow paths are disposed at an interval in the axial direction of the housing, and a passage cross-sectional shape of the second cooling water flow paths has a quadrilateral shape with unequal sides.

9. The electric compressor according to claim 2,
wherein a passage cross-sectional area in the first cooling water flow paths and a passage cross-sectional area in the second cooling water flow path are the same as each other.

10. The electric compressor according to claim 3,
wherein a passage cross-sectional area in the first cooling water flow paths and a passage cross-sectional area in the second cooling water flow path are the same as each other.
